(19) United States
(12) Patent Application Publication
(10) Pub. No.: US 2026/0201909 A1
(43) Pub. Date: Jul. 16, 2026

(54) SLIDING DEVICE AND FLUIDIC CYLINDER

(71) Applicant: Festo SE & Co. KG, Esslingen (DE)

(72) Inventor: Daniel WALDNER, Nürtingen (DE)

(21) Appl. No.: 19/446,446

(22) Filed: Jan. 12, 2026

(30) Foreign Application Priority Data
Jan. 14, 2025 (DE) 102025101149.4

(51) Int. Cl. F15B 15/14; F16C 17/02

(52) U.S. Cl. CPC F15B 15/1428; F15B 15/1447; F16C 17/02

(57) ABSTRACT

A sliding device with a base ring and a sliding ring. The sliding ring can be brought onto the base ring by way of a sliding movement which runs along a sliding axis, so that a sliding surface of the sliding ring which faces the base ring at least partly overlaps a base surface of the base ring which faces the sliding ring. The base ring in a base venting section on the base surface includes several base deepenings and base support segments which are each arranged in an alternating manner, in which the sliding ring in a sliding venting section on the sliding surface includes several sliding deepenings and sliding support segments which are each arranged in an alternating manner.

### CROSS REFERENCE TO RELATED APPLICATION

This application claims priority to German Patent Application No. 102025101149.4 filed January 14, 2025, which is incorporated by reference.

### BACKGROUND

The invention relates to a sliding device and a fluidic cylinder.

A sliding device comprises a base ring and a sliding ring, wherein by way of a sliding movement which runs along a sliding axis, the sliding ring can be brought onto the base ring in a manner such that the sliding device is brought into a venting position in which a working fluid can pass through the sliding device.

A fluidic cylinder comprises a cylinder housing in which a working recess is formed. A working piston which is linearly movable along a movement axis by way of subjection of the working recess to working fluid is received in the working recess. The working piston is connected to a piston rod which passes through an end cap which is arranged on the cylinder housing at the end side. The working piston can be moved into an end position which is situated in the proximity of the end cap.

### SUMMARY

It is the object of the invention to be able to provide a simple, reliable and constant venting and/or pressurisation.

The object is achieved by a sliding device according to claim 1 and a fluidic cylinder according to claim 15.

The sliding device according to the invention comprises a base ring and a sliding ring, wherein the sliding ring can be brought onto the base ring by way of a sliding movement which runs along a sliding axis, so that a sliding surface of the sliding ring which faces the base ring at least partly overlaps a base surface of the base ring which faces the sliding ring, wherein the base ring in a base venting section on the base surface comprises several base deepenings and base support segments which are each arranged in an alternating manner, wherein the sliding ring in a sliding venting section on the sliding surface comprises several sliding deepenings and sliding support segments which are each arranged in an alternating manner, wherein in a venting position in which the base venting section and the sliding venting section at least partly overlap one another, given a constant distance of the base ring to the sliding ring with respect to the sliding axis, an overlapping area of the base deepenings with the sliding deepenings is constant independently of a rotation position of the base ring relative to the sliding ring about the sliding axis.

Preferably, the sliding device is designed for usage for, which is to say with, a fluidic cylinder. According to an alternative preferred embodiment, the sliding device is designed for use in a filling facility, regarding which a constant delivery performance can be achieved independently of the rotation position of the base ring relative to the sliding ring about the sliding axis. According to a further alterative preferred embodiment, the sliding device is designed for use as the pressurisation for a rotatable rod in a plain bearing, regarding which a constant pressurisation can be achieved independently of the rotation position of the base ring relative to the sliding ring about the sliding axis.

The sliding ring can be brought onto the base ring in a manner such that as soon as the base surface and the sliding surface partly overlap, a further bringing of the sliding ring onto the base ring is assisted by way of a continuation of the sliding movement due to the sliding surface sliding away on the base surface. The base surface herein serves as a plain bearing surface for the sliding surface, by which means the base ring serves as a plain bearing for the sliding ring. The sliding ring can be removed from the base ring by way of a movement which is directed opposite to the above movement. Hereby, the base ring at all events also serves as a plain bearing for the sliding ring until the base surface and the sliding surface once again no longer partly overlap.

Preferably, the sliding ring is formed from an elastomer, in particular from a thermoplastic elastomer. For example, the sliding ring is formed from a polyurethane, an acrylonitrile butadiene rubber, a fluorinated rubber or ethylene-propylene-diene rubber. Further preferably, the base ring is formed from a metal or a plastic, in particular thermoplastic plastic. For example, the base ring is formed from a polyoxymethylene, a polyphenylene sulphide with a base surface of polytetrafluoroethylene, a bronze alloy or an anodised aluminium. Alternatively, the base ring can be designed of glass for applications in the field of laboratory equipment or filling facilities.

The sliding movement runs along the sliding axis and thus in a linear manner. Depending on the movement direction, as described above, with the sliding movement the sliding ring can be brought onto the base ring or removed from this.

In the base venting section, the base ring on the base surface comprises several base deepenings and base support segments which are each arranged in an alternating manner. The base deepenings do not contribute to the aforementioned plain bearing function of the base ring since the sliding ring cannot support itself on these due to the geometry. It is for this that the base support segments are provided. A base deepening and base support segment together form a pair, wherein several such pairs are arranged successively on the base surface.

In the sliding venting section, the sliding ring on the sliding surface comprises sliding deepenings and sliding support segments which are each arranged in an alternating manner. Just as the base deepening do not contribute to the aforementioned plain bearing function of the base ring, the sliding ring cannot support itself on the base surface by way of the sliding deepenings on account of the geometry. It is in particular for this that the sliding support segments are provided. Preferably, the sliding support segments support themselves on the base support segments, which is to say they slide on these during the sliding movement. One further preferably envisages neither the sliding support segments entering into the sliding deepenings nor the sliding support segments entering into the base deepenings. Alternatively or supplementarily, the sliding support segments and/or the base support segments serve for the stiffening of the sliding ring and of the base ring respectively. According to a preferred alternative, the sliding support segments and/or the base support segments serve exclusively for the stiffening of the sliding ring or of the base ring, but not for the support of the sliding ring on the base ring or of the base ring on the sliding ring.

The base deepenings and/or the sliding deepenings can each be deepened perpendicularly. Alternatively, the base deepenings and/or the sliding deepenings can each be deepened in a tapering manner. Further alternatively, the base deepenings and/or the sliding deepenings can each be deepened in a widening manner. A perpendicular deepening is characterised in that a constant deepening cross section is present independently of the depth. A tapering deepening is characterised in that the deepenings cross section becomes increasingly smaller with an advancing depth. A widening deepening is characterised in that the deepening cross section becomes increasingly larger with an advancing depth. Preferably, the base deepenings are deepened in an essentially perpendicular manner. Further preferably, the sliding deepenings are deepened in an essentially perpendicular manner. Alternatively, the sliding deepenings are deepened in a tapering manner.

In the venting position, the base venting section and the sliding venting section at least partly overlap one another. In the venting position, a working fluid can herewith pass through the sliding device via the base deepenings and the sliding deepenings. A passage of working fluid through the sliding device is also denoted as pressurising or venting depending on the direction of the passage. In particular, a working recess of a fluidic cylinder can be pressurised, which is to say that working fluid flows into the working recess, or vented, which is to say working fluid flows out of the working recess. The sliding device is designed such that given a constant distance of the base ring to the sliding ring with respect to the sliding axis, the overlapping area of the base deepenings with the sliding deepenings is constant independently of a rotation position of the base ring relative to the sliding ring about the sliding axis.

Basically, the greater the overlapping area, the more working fluid can pass through the sliding device in the aforementioned manner. The overlapping area can be enlarged by way of the sliding ring being brought further onto the base ring, so that an overlapping length pronounced along the sliding axis is enlarged. The overlapping area can further be enlarged by way of a respective width of the base deepenings and/or a respective width of the sliding deepenings being designed larger. Furthermore, the maximum of possible working fluid which passes through the sliding device can be influenced by a cross section of the sliding deepenings and/or base deepenings which extends perpendicularly to the overlapping area. The greater this cross section, the greater is the aforementioned maximum. Whilst taking into account that which has been stated above, the maximum of possible working fluid which passes through the sliding device is therefore influenced on the one hand by the aforementioned overlapping area and on the other hand by the aforementioned cross section. Preferably, at all events, in the venting position one envisages the maximum of working fluid which can possibly pass through the sliding device being limited exclusively by the aforementioned cross section.

When the base venting section and the sliding venting section at least partly overlap one another, an overlapping width which runs perpendicularly to the overlapping length at all events is constant independently of the rotation position of the base ring relative to the sliding ring about the sliding axis. This means that the overlapping width is not influenced by a rotation of the base ring and the sliding ring to one another with respect to the sliding axis. This can be achieved as is described hereinafter.

The base deepenings and the sliding deepenings can be designed and arranged such that when in a first position a certain base deepening and a certain sliding deepening overlap one another and the base ring and the sliding ring are rotated to one another with respect to the sliding axis towards a second position in which this certain base deepening and this certain sliding deepenings no longer overlap, with the reducing overlapping an overlapping of another base deepening with another sliding deepening increases to the same extent. Accordingly, a local reduction of the overlapping at one location is compensated to the same extent by a local increase of the overlapping at another location.

Advantageous further developments of the invention are the subject-matter of the dependent claims.

Preferably, the base deepenings, the base support segments, the sliding deepenings and/or the sliding support segments are each designed in the same manner. Further preferably, the base deepenings, the base support segments, the sliding deepenings and the sliding support segments are each designed in the same manner. Herein, with respect to the base deepenings, being designed in the same manner means that within a group of base deepenings, an arbitrary individual base deepening is the same as an arbitrary other individual base deepening. Herein, with respect to the base deepenings, designed in the same manner does not necessarily mean that an individual base deepenings is the same as an individual sliding deepening. In contrast, the base deepenings and the sliding deepenings are preferably designed in an unequal manner and/or the base support segments and the sliding support segments are designed in an unequal manner. Analogously, designed in the same manner with respect to the base support segments means that within a group of base support segments, an arbitrary individual base support segment is the same as an arbitrary other individual base support segment. Furthermore, this analogously applies to the sliding deepenings and the sliding support segments.

Preferably, for at least one of the following pairs, a respective width of a first pair part of the pair and a respective width of a second pair part of the pair are not equal: base deepenings and base support segments, sliding deepenings and sliding support segments, base deepenings and sliding deepenings, base deepenings and sliding support segments, base support segments and sliding deepenings, base support segments and sliding support segments. For example, for the pair which consists of the base deepenings and the base support segments and regarding which the base deepenings are the first pair part and the base support segments the second pair part, this means that the respective width of the base deepenings and the respective width of the base support segments are unequal.

Preferably, the base deepenings, the base support segments, the sliding deepenings and the sliding support segments are each designed in the same manner, wherein in the radial direction neither does a base ring division which corresponds to a sum of a respective width of the base deepenings and a respective width of the base support segments correspond to a sliding ring division which corresponds to a sum of a respective width of the sliding deepenings and a respective width of the sliding support segments, or to an integer multiple of the sliding ring division, nor does the sliding ring division correspond to an integer multiple of the base ring division. By way of this, in a preferred manner, it can be ensured that given a constant distance of the base ring to the sliding ring with respect to the sliding axis, the same overlapping area of the base deepenings with the sliding deepenings is present at every rotation position.

Herein, the base ring division corresponds to the sum of the width of an individual base deepening and the width of an individual base support segment. The base ring division further corresponds to a distance between a middle point of a base deepening and a middle point of a further base deepening which is arranged next to this base deepening. In the same manner, the base ring division corresponds to a distance between a middle point of a base support segment and a middle point of a further base support segment which is arranged next to this base support segment. That which has been stated above with regard to the base ring division applies in the same manner to the sliding ring division.

Preferably, a respective width of the base deepenings is larger than a respective width of the base support segments and/or a respective width of the sliding deepenings is larger than a respective width of the sliding support segments. By way of this, a large overlapping surface of the base deepenings with the sliding deepenings can be provided, so that a larger quantity of working fluid can pass through the sliding device via the base deepenings and the sliding deepenings.

Alternatively, a respective width of the base deepenings is smaller than a respective width of the base support segments and/or a respective width of the sliding deepenings is smaller than a respective width of the sliding support segments. By way of this, the sliding support segments can support themselves on the base support segments on a large surface, so that the sliding ring can be reliably supported on the base ring.

Preferably, the base deepenings, the base support segments, the sliding deepenings and/or the sliding support segments are orientated along the sliding axis. This means in particular that a respective longest extension of the base deepenings, base support segments, sliding deepenings and/or sliding support segments runs along the sliding axis. By way of this, one succeeds in a rotation of the sliding ring with respect to the base ring with regard to the sliding axis and caused by the respective base deepenings, base support segments, sliding deepenings and/or sliding support segments being prevented when bringing the sliding ring onto the base ring. Preferably, by way of this, one succeeds in the sliding ring being guided along the sliding axis on being brought onto the base ring, on account of the respective base deepenings, base support segments, sliding deepenings and/or sliding support segments. Further preferably, the base deepenings, the base support segments, the sliding deepenings and the sliding support segments are orientated along the sliding axis.

Preferably, the base ring comprises a stop which limits the sliding movement of the sliding ring along the sliding axis. Inasmuch as this is concerned, the sliding ring can be brought so far onto the base ring by way of the sliding movement until the stop prevents a continuation of the sliding movement. Preferably, the stop projects from the base surface perpendicularly to the sliding axis in the direction of the sliding surface.

Preferably, the base ring on the base surface comprises a radially circumferentially closed base sealing section and/or the sliding ring on the sliding surface comprises a radially circumferentially closed sliding sealing section. By way of this, one succeeds in working fluid not being able to pass through the sliding device via the base deepenings and the sliding deepenings when the base ring and the sliding ring merely overlap in the region of the base sealing section and/or of the sliding sealing section. Accordingly, a sealing function, concerning which working fluid cannot pass through the sliding device via the base deepenings and the sliding deepenings, is provided for a part of the sliding movement, which is to say the bringing of the sliding ring onto the base ring, and a venting function, concerning which working fluid can pass through the sliding device via the base deepenings and the sidling deepenings, is provided for another part of the sliding movement.

Inasmuch as the base sealing section is provided, the base support segments extend from this or into this. Inasmuch as the sliding sealing section is provided, the sliding support segments extend from this or into this. Preferably, the base sealing section and/or the sliding sealing section is arranged in a manner such that the sealing function is provided at the beginning of the sliding movement, which is to say firstly, and the venting function at the end of the sliding movement, which is to say thereafter. Further preferably, the base sealing section and/or the sliding sealing section are arranged opposite to the stop.

Preferably, the base surface faces outwards and the sliding surface faces inwards. Accordingly, the base surface is located between the sliding surface and the sliding axis when bringing on the base ring. Herewith, the sliding ring surrounds the base ring at least in the overlapping region.

Preferably, the base ring comprises a base sliding surface which is arranged lying opposite the base surface and on which a piston rod of a fluidic cylinder can be mounted in a slidingly movable manner. Herewith, the sliding device is not only suitable for providing a venting function but furthermore with regard to the base ring is suitable for functioning as a plain bearing for the working piston.

Preferably, venting slots pass through the base sliding surface, wherein further preferably the venting slots run along the sliding axis. In particular, the venting slots serve for providing a venting function independently of the base venting section and the sliding venting section. Preferably, a venting function is provided by way of the venting slots, such a venting function also occurring when the sliding device is not situated in the venting position.

Preferably, the base ring comprises at least one venting channel through which working fluid can pass through the sliding device independently of the position of the sliding ring to the base ring with regard to the sliding axis. By way of this, working fluid can continuously pass through the sliding device, for example a working recess of a fluidic cylinder can be continuously vented or pressurised, independently of the position of the sliding ring. The share of the working fluid which continuously passes through can preferably be set according to requirements by way of a suitable design of the venting channel, in particular with regard to its cross section. If working fluid is to continuously pass through the sliding device to a greater extent, then the cross section of the venting channel is to be selected larger than if working fluid is to continuously pass through the sliding device to a lesser extent.

Preferably, the venting channel passes through the stop from the inside to the outside, wherein at least one of the venting slots runs out into the venting channel. The venting channel runs from the inside to the outside, which is to say coming from a region which is arranged at least adjacently to a circumferential surface of the working piston, towards an outer circumferential surface of the base ring. Herewith, working fluid which is present around the working piston or in the region of the working piston can be vented to the outside via the venting slots and the venting channel. Further preferably, several venting channels are provided and each venting slot runs out into an individual venting channel which is only assigned to this venting slot.

The fluidic cylinder according to the invention comprises a sliding device as has been described above, and a cylinder housing in which a working recess is formed, in which working recess a working piston is received, said working piston being linearly movable along a movement axis by way of subjecting the working recess to working fluid, wherein the working piston is connected to a piston rod which passes through an end cap which is arranged on the cylinder housing at the end side, wherein the base ring is fixed to the end cap, wherein the sliding ring is fixed to the working piston.

The fluidic cylinder can be a single-acting or double-acting fluidic cylinder. If the fluidic cylinder is designed in a single-acting manner, then the working piston can only be moved in a single direction by way of subjecting the working recess to working fluid. In order to set back the working piston, for example one can provide a suitable spring by way of which a restoring spring force is exerted upon the working piston. If the fluidic cylinder is designed in a double-acting manner, the working piston can be moved in a first direction by way of subjecting a first part of the working recess to working fluid and moved in a second direction which is opposite to the first direction by way of subjecting a second part of the working recess to working fluid.

Preferably, the movement axis runs parallel to the sliding axis. By way of this, a resistance which is opposite to the sliding movement can be reduced.

Preferably, the end cap comprises a piston rod seal which bears on a sealing surface of the piston rod in a sealing manner.

Preferably, in the venting position working fluid can exit from the working recess via the sliding deepenings and the base deepenings into an environment which surrounds the fluidic cylinder. The exit of working fluid into the surroundings in particular is also effected via the end cap.

Preferably, the base ring functions as a plain bearing for the working piston or the piston rod.

### BRIEF DESCRIPTION OF THE DRAWINGS

The invention is hereinafter explained in more detail by way of the accompanying drawings and in these are shown:

FIG. 1 a sliding device in a sectioned view,

FIG. 2 a base ring of the sliding device represented in FIG. 1, in an isometric view,

FIG. 3 the base ring which is represented in FIG. 2, in a further isometric view,

FIG. 4 a sliding ring of the sliding device represented in FIG. 1, in an isometric view,

FIG. 5 the sliding ring which is represented in FIG. 4, in a further isometric view,

FIG. 6 a base venting section of the base ring represented in FIG. 2 and 3 and a sliding venting section of the sliding ring represented in FIG. 4 and 5, in a first rotation position in an abstract view,

FIG. 7 the arrangement which is represented in FIG. 6, in a second rotation position,

FIG. 8 the arrangement which is represented in FIG. 6 and 7, in a third rotation position,

FIG. 9 the arrangement which is represented in FIG. 6 to 8, in a fourth rotation position, and

FIG. 10 a fluidic cylinder with two base rings which are represented in FIG. 2 and 3 and two sliding rings which are represented in FIG. 4 and 5, in a sectioned view.

### DETAILED DESCRIPTION

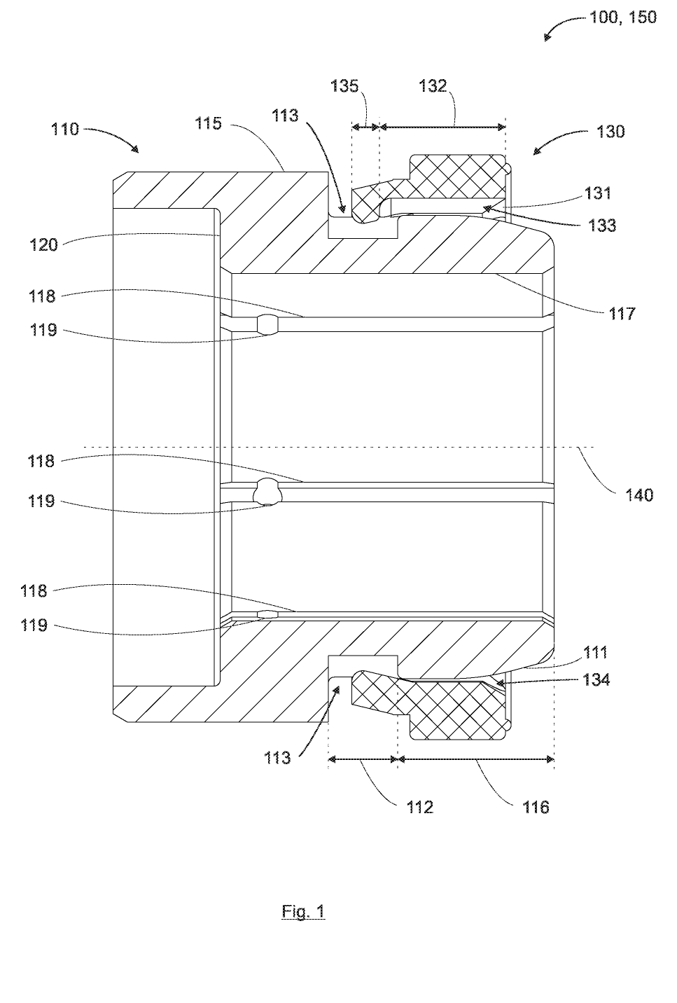

FIG. 1 shows a sliding device 100 in a sectioned view. The sliding device 100 comprises a base ring 110 and a sliding ring 130. The sliding ring 130 can be brought onto the base ring 110 by way of a sliding movement which runs along the sliding axis 140. The sliding movement for bringing the sliding ring 130 onto the base ring 110 runs from the right to the left, given the arrangement which is represented in FIG. 1. The sliding ring 130 which is brought onto the base ring 110 can be removed from the base ring 110 by way of a sliding movement which runs from the left to the right.

The base ring 110 comprises a base surface 111 which faces the sliding ring 130. The sliding ring 130 comprises a sliding surface 131 which faces the base ring 110. In the arrangement which is represented in FIG. 1, the sliding surface 131 partly covers the base surface 111. Purely by way of example, the base surface 111 extends further along the sliding axis 140 than the sliding surface 131. Further by way of example, as is represented in FIG. 1, the sliding ring 130 with regard to its extension along the sliding axis 140 in the region of the base surface 111 can be brought completely onto the base ring 110. Purely by way of example, the base surface 11 faces outwards and the sliding surface 131 faces inwards.

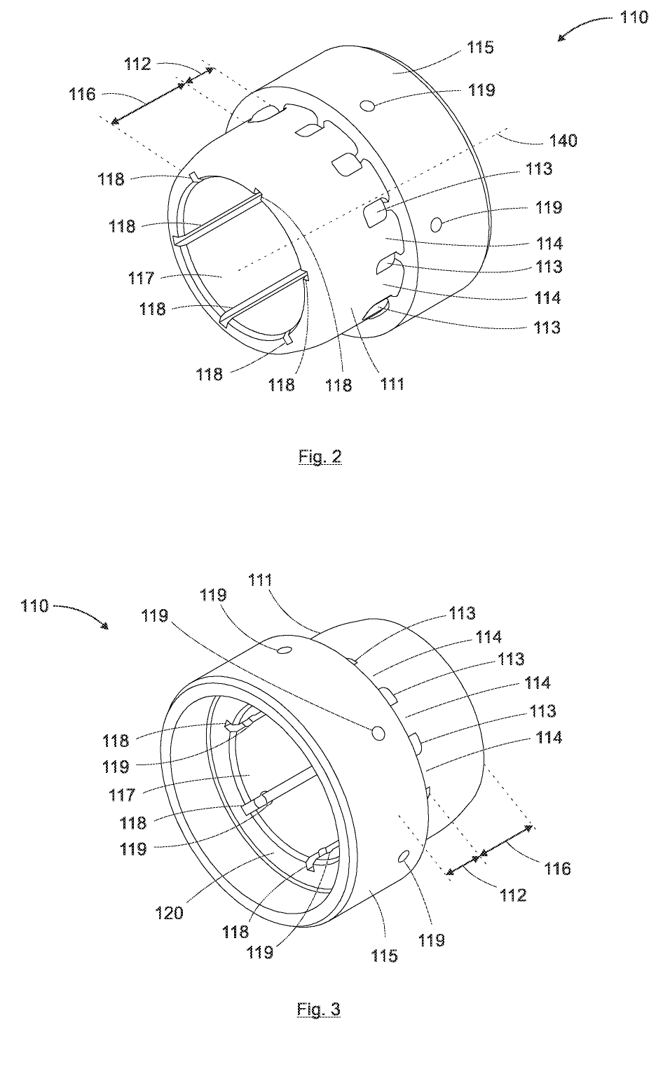

FIG. 2 and 3 show the base ring 110 which is represented in FIG. 1, in each case in a different isometric view. The base ring 110 comprises a base venting section 112 on the base surface 111. The base ring 110 in the base venting section 112 comprises several base deepening 113 and base support segments 114 which are each arranged in an alternating manner.

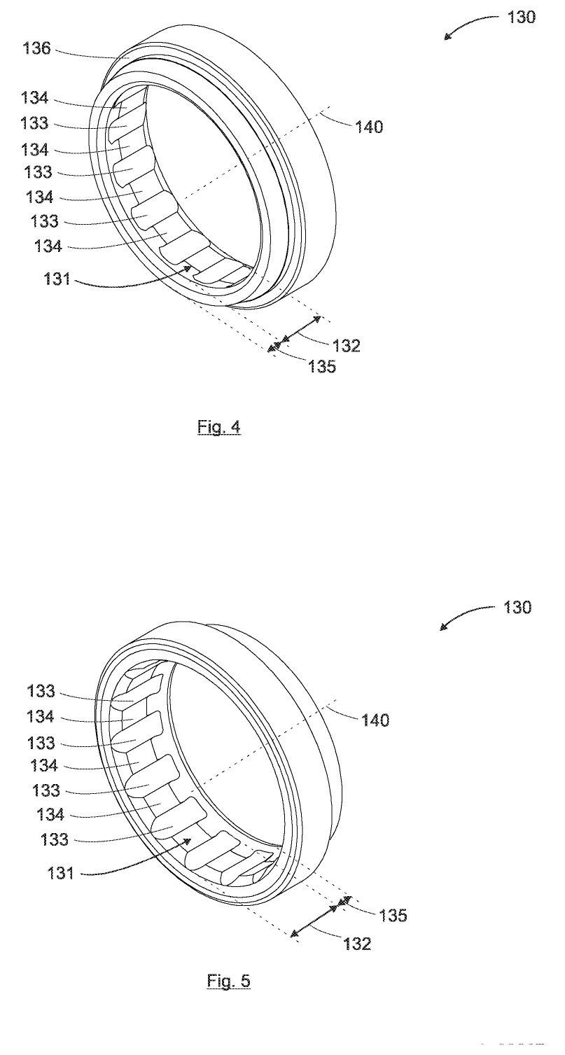

FIG. 4 and 5 show the sliding ring 130 which is represented in FIG. 1, each in a different isometric view. The sliding ring 130 comprises a sliding venting section 132 on the sliding surface 131. The sliding ring 130 in the sliding venting section 132 comprises several sliding deepenings 133 and sliding support segments 134 which are each arranged in an alternating manner. Purely by way of example, the sliding ring 130 consists of a flexible material, in particular of plastic, for example of silicone or rubber such as an ethylene-propylene-diene rubber, fluorinated rubber or chloroprene rubber.

With regard to the arrangement which is represented in FIG. 1, the sliding device 100 is situated in a venting position 150 in which the base venting section 112 and the sliding venting section 132 at least partly overlap one another.

Preferably, the base deepenings 113 comprise rounded edges as are represented in FIG. 2 and 3. Further preferably, the sliding deepenings 133 comprise rounded edges as are represented in FIG. 4 and 5. In such a manner, when bringing the sliding ring 130 onto the base ring 110, one can prevent the base ring 110 from being damaged by the sliding ring 130 and/or the sliding ring 130 from being damaged by the base ring 110.

Preferably, the base support segments 114 in the base venting section 112 result as a structural remainder of the base ring 110 next to the base deepenings 113 or as a corresponding remainder after the base deepenings 113 have been brought into the base ring 110. Accordingly, the base support segments 114 preferably do not protrude from the remaining base ring 110, regarding which no base deepenings 113 are arranged, inasmuch as such a region exists. Preferably, that which has been stated above with respect to the base support segments 114 and the base deepenings 113 applies in the same manner to the sliding support segments 134 and the sliding deepenings 133.

Purely by way of example, the base deepenings 113, the base support segments 114, the sliding deepenings 133 and the sliding support segments 134 are orientated along the sliding axis 140. This can be recognised (cf. FIG. 1 to 5) in that a respective longest extension of the base deepenings 113, base support segments 114, sliding deepenings 133 and sliding support segments 134 runs along the sliding axis 140.

Preferably, the base ring 1110 comprises a stop 115 which limits the sliding movement of the sliding ring 130 along the sliding axis 140. The stop 115 purely by way of example projects outwards from the base ring 110. Accordingly, the base ring 110 in the region of the stop 115 has a larger outer diameter than in an adjacent region. The limitation of the sliding movement can be recognised in FIG. 1. A sliding movement which in FIG. 1 runs from the right to the left is limited to the left by way of the stop 115. Accordingly, with regard to the arrangement which is represented in FIG. 1, the sliding ring 130 cannot be brought onto the base ring 110 to an unlimited extent to the left, but is prevented from a continuation of the aforementioned sliding movement at the right edge of the stop 115.

Preferably, the base ring 110 comprises a base shoulder 120 which purely by way of example is arranged lying at the inside and with respect to the sliding axis 140 in the region of the stop 115. The base shoulder 120 can be used for example for the secure receiving of a seal.

Preferably, the base ring 110 on the base surface 111 comprises a radially circumferentially closed base sealing section 116. Base deepenings 113 do not pass through the base sealing section 116, which is to say the base deepenings 113 coming from the base venting section 112 do not extend into the base sealing section 116. Further preferably, the sliding ring 130 on the sliding surface 131 comprises a radially circumferentially closed sliding sealing section 135. The sliding deepenings 133 do not pass through the sliding sealing section 135 which is to say the sliding deepenings 133 coming from the sliding venting section 132 do not extend into the sliding sealing section 135. If the base sealing section 116 and the sliding sealing section 135 overlap with regard to the sliding axis 140, then one can prevent working fluid from passing via the sliding deepenings 133 and the base deepenings 113.

Preferably, the sliding deepenings 133 are each limited at one side along the sliding axis 140, purely by way of example at the side which faces in the direction of the sliding sealing section 135 and each run out at another side, purely by way of example at the side which faces away from the sliding sealing section 135. This means that the sliding deepenings 133 are not limited at the side which faces away from the sliding sealing section 135. Alternatively, the sliding deepenings 133 can be limited at both sides or run out at both sides.

Preferably, the base deepenings 113 are each limited along the sliding axis 140 at both sides, specifically on the one hand at a side which faces the stop 115 and on the other hand at a side which is away from the stop 115. Alternatively, the base deepenings 113 could also run out at one side or at both sides, as described above with respect to the sliding deepenings 113.

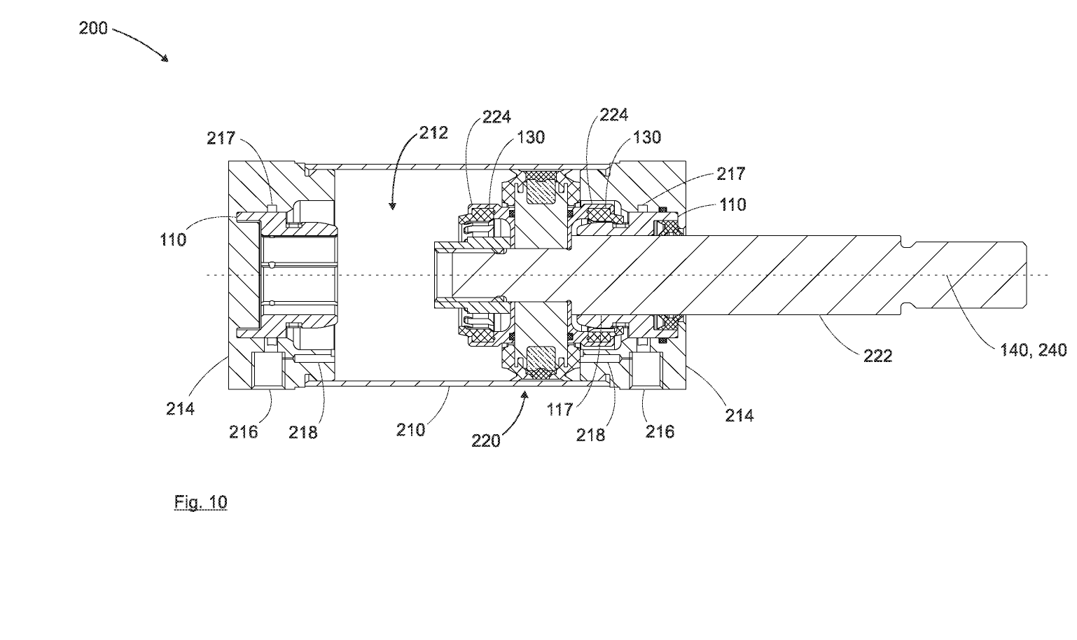

Preferably, the base ring 110 comprises a base sliding surface 117 which is arranged lying opposite the base surface 111 and on which a piston rod 222 of a fluidic cylinder 200 can be mounted in a slidingly movable manner (cf. FIG. 10). Further preferably, venting slots 118 pass through the base sliding surface 117, wherein in particular the venting slots 118 run along the sliding axis 140. Further preferably, venting channels 119 which run from the inside to the outside pass through the stop 115, wherein the venting slots 118 run into the venting channels 119. Purely by way of example, a venting slot 118 runs into a venting channel 119. Purely by way of example, six venting slots 118 and venting channels 119 are provided. Moreover, only one venting slot 118 can be provided or two, three, four, five or more than six, for example ten, fifteen or twenty venting slots 118 and venting channels 119 can be provided.

Preferably, the sliding ring 130 comprises a sliding shoulder 136 as is represented in FIG. 4 and 5. The sliding shoulder 136 purely by way of example projects away from the sliding ring 130 to the outside. Accordingly, the sliding ring 130 has a larger outer diameter in the region of the sliding shoulder 136 than in a region which is adjacent to this. The sliding shoulder 136 can be used to couple the sliding ring 130 to a further component with regard to the sliding axis 140, in particular to a further component of the fluidic cylinder 200, for example so that the sliding ring 130 can be moved along the sliding axis 140 by way of this further component. For example, a coupling element 224 is provided as such a further component of the fluidic cylinder 200 (cf. FIG. 10), said coupling element being fixed to the working piston 220 or to the piston rod 222. Further by way of example, two coupling elements 224 are provided.

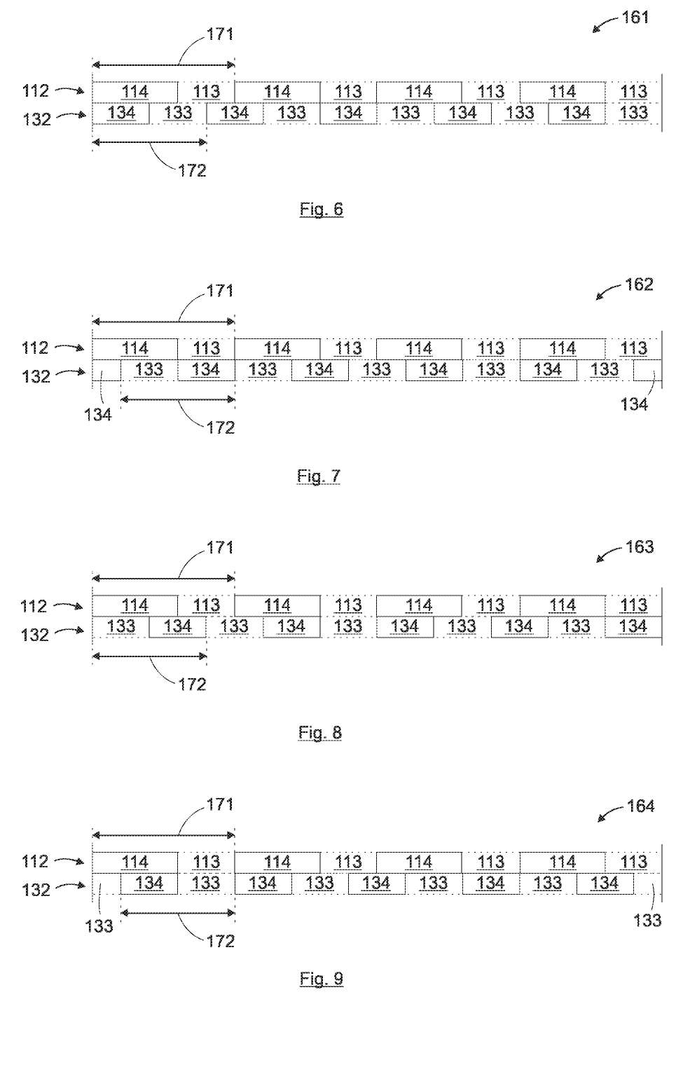

FIG. 6 to 9 show the base venting section 112 and the sliding venting section 132 in different rotation positions of an abstract view. A first rotation position 161 is represented in FIG. 6, a second rotation position 162 in FIG. 7, a third rotation position 163 in FIG. 8 and a fourth rotation position 164 in FIG. 9. With regard to the abstract representations which are shown in FIG. 6 to 9, in each case four pairs of a base support segment 114 and a base deepening 113 are represented and in each case five complete pairs of a sliding support segment 134 and a sliding deepening 133. With regard to the representation which is shown in FIG. 7, half a sliding support segment 134 is each shown in the representation at the right edge and at the left edge. With regard to the representation which is shown in FIG. 9, in each case half a sliding deepening 133 is shown in the representation at the right edge and at the left edge.

Purely by way of example, a respective width of the base deepenings 113 is smaller than a respective width of the base support segments 114. By way of this, the sliding support segments 134 can support themselves on the base support segments 114 on a large surface, so that the sliding ring 130 can be reliably supported on the base ring 130. A structural stability of the base ring 110 is increased due to the base support segments 114 which are designed in a suitably wide manner as described above. By way of this increase of stability, a mounting of the working piston 220 or of the piston rod 222 can be improved when the base ring 110 functions as a plain bearing for the working piston 220 or the piston rod 222. Further by way of example, a respective width of the sliding deepenings 133 is as large as a respective width of the sliding support segments 134.

The base support segments 114 and base deepenings 113 (cf. FIG. 2 and 3) which are actually distributed along circles or over the circumference, as well as the sliding support segments 134 and the sliding deepenings 133 (cf. FIG. 4 and 5) are each represented in a simplified manner arranged running next to one another along a straight line in FIG. 6 to 9. In other words the respective radial direction of the base venting section 112 and of the sliding venting section 132 is represented as a linear direction. With regard to the radial direction, a sum of a respective width of the base deepenings 113 and of a respective width of the base support segments 114 results in a base ring division 171 which for reasons of a better overview in FIG. 6 to 9 is only characterised once by a reference numeral. With regard to the radial direction, a sum of a respective width of the sliding deepenings 133 and of a respective width of the sliding support segments 134 results in a sliding ring division 172 which for reasons of a better overview in FIG. 6 to 9 is only characterised once by a reference numeral.

Preferably, as is represented in FIG. 6 to 9, in the radial direction neither the base ring division 171 corresponds to the sliding ring division 172 or an integer multiple of the sliding ring division 172 nor does the sliding ring division 172 correspond to an integer multiple of the base ring division 171. As described above, concerning the equally long details of the base venting section 112 and of the sliding venting section 132 which are represented in FIG. 6 to 9, four pairs of a base deepening 113 with a base support segment 114 as well as five pairs of a sliding deepening 133 and a sliding support segment 134 are present. Accordingly, the base ring division 171 with regard to the radial length which is represented as a whole or with regard to the radial section which is represented as a whole corresponds to a quarter and the sliding ring division 172 to a fifth. The base ring division 171, thus a quarter, neither corresponds to the sliding ring division 172, thus a fifth, nor to an integer multiple of the sliding ring division 172, thus an integer multiple of a fifth, for example two fifths, three fifths, four fifths or one. Furthermore, the sliding ring division 172, thus a fifth, also does not correspond to an integer multiple of the base ring division 171 thus for example half, three quarters or one.

It is further possible for the representations of t FIG. 6 to 9 to merely be understood as a respective detail of the base venting section 112 and of the sliding venting section 132. The base venting section 112 and the sliding venting section 132 can each comprise an integer multiple of the details which are represented in the FIG. 6 to 9.

By way of FIG. 6 to 9, it can be recognised that in the venting position 150 (cf. FIG. 1), given a constant distance of the base ring 110 to the sliding ring 130 with respect to the sliding axis 140, an overlapping area of the base deepenings 113 with the sliding deepenings 113 is constant independently of the rotation position 161, 162, 163, 164 of the base ring 110 relative to the sliding ring 130 about the sliding axis 140. Purely by way of example, the aforementioned overlapping area in the radial direction, as is represented in FIG. 6 to 9, extends over a width of two sliding deepenings 133 which further by way of example corresponds to the sliding ring division 172, in each rotation position 161, 162, 163, 164. The rotation positions 161, 162, 163, 164 are merely to be understood as exemplary rotation positions. The sliding device 100 can herein assume further rotation positions which lie between the rotation positions 161, 162, 163, 164 which are represented in FIG. 6 to 9.

FIG. 10 shows the fluidic cylinder 200 in a sectioned view. Purely by way of example, the fluidic cylinder 200 comprises two base rings 110 and two sliding rings 130. Purely by way of example, the two base rings 110 and the two sliding rings 130 are each aligned along the same sliding axis 140. The sectioned view which is shown in FIG. 10 lies in the same section plane as the sectioned view which is shown in FIG. 1. With regard to the sliding device 100 which is shown in FIG. 1, the base ring 100 is arranged at the left, whereas the sliding ring 130 is arranged at the right. This sliding device 100 therefore corresponds to the combination of the base ring 110 and the sliding ring 130, which is shown at the left in FIG. 10. Differently to that which is shown in FIG. 1, this left sliding device 100 is not in the venting position 150 in FIG. 10. In contrast, the left sliding ring 130 is distanced to the right from the left base ring 110. In contrast, the sliding device 100 which is formed by the right sliding ring 130 and the right base ring 110 and which is denoted as the right sliding device 100 is in its venting position 150. This venting position 150 is not provided with a reference numeral in FIG. 10.

The fluidic cylinder 200 comprises a cylinder housing 210 in which a working recess 212 is formed. The fluidic cylinder 200 further comprises the working piston 220 which is received in the working recess 212. The working piston 220 is linearly movable along the movement axis 240 by way of subjecting the working recess 212 to working fluid. Purely by way of example, the movement axis 240 and the sliding axis 140 are congruent. The fluidic cylinder 200 further comprises the piston rod 222 which is connected to the working piston 220. The piston rod 222 is movable to the same extent by way of the movement of the working piston 220. The piston rod 222 passes through an end cap 214 which are arranged on the cylinder housing 210 at the end side. Purely by way of example, the piston rod 222 passes through the end cap 214 which is arranged at the right. Further by way of example, the fluidic cylinder 200 comprises a further end cap 214 which is arranged for example at the left. The piston rod 222 does not pass through this left end cap 214. Purely by way of example, the base ring 110 which is represented at the right in FIG. 10 functions as a plain bearing for the piston rod 222.

By way of example, the left base ring 110 is fixed to the left end cap 214 and the right base ring 110 is fixed to the right end cap 214. Further by way of example, the left sliding ring 130 and the right sliding ring 130 are each fixed to the working piston 220.

Preferably, in the venting position 150 working fluid via the sliding deepenings 133 and the base deepenings 113 can get out of the working recess 212 into an environment which surrounds the fluidic cylinder 200 and is not provided with a reference numeral. For this, the fluidic cylinder 200 purely by way of example comprises a fluid connection 216, in particular two fluid connections 216, of which in each case one is assigned to a sliding device 100 and is arranged in one of the two end caps 214. With regard to the arrangement which is represented in FIG. 10, working fluid via the sliding deepenings 133 of the right sliding ring 130 and the base deepenings 113 of the right base ring 100 can exit out of the working recess 212 into the environment. Since with regard to the arrangement which is represented in Fig, 100, the left sliding device 100 is not situated in the venting position 150, working fluid cannot exit out of the working recess 212 into the environment via the sliding deepenings 133 of the left sliding ring 130 and the base deepenings 113 of the left base ring 100.

Purely by way of example, the fluidic cylinder 200 at the end caps 214 comprises a radially circumferential venting groove 217 which runs out into the fluid connection 216. The venting groove 217 is fluidically connected to the at least one venting channel 119, so that the working recess 212 can be pressurised and vented independently of the position of the sliding ring 130 to the base ring 140 which is assigned to it.

Further by way of example, a bypass opening 218 is formed in each of the end caps 214, said bypass opening 212 on the one hand running out into the working recess 212 and on the other hand into the respective fluid connection 216. The working recess 212 can also be pressurised and vented via the bypass opening 218.

1. A sliding device comprising:
a base ring and a sliding ring,
wherein the sliding ring can be brought onto the base ring by way of a sliding movement which runs along a sliding axis, so that a sliding surface of the sliding ring which faces the base ring at least partly overlaps a base surface of the base ring which faces the sliding ring,
wherein the base ring in a base venting section on the base surface comprises several base deepenings and base support segments which are each arranged in an alternating manner,
wherein the sliding ring in a sliding venting section on the sliding surface comprises several sliding deepenings and sliding support segments which are each arranged in an alternating manner,
wherein in a venting position in which the base venting section and the sliding venting section at least partly overlap one another, given a constant distance of the base ring to the sliding ring with respect to the sliding axis, an overlapping area of the base deepenings with the sliding deepenings is constant independently of a rotation position of the base ring relative to the sliding ring about the sliding axis.

2. The sliding device according to claim 1, wherein the base deepenings, the base support segments, the sliding deepenings and/or the sliding support segments in each case are designed in the same manner.

3. The sliding device according to claim 2, wherein for at least one of the following pairs, a respective width of a first pair part of the pair and a respective width of a second pair part of the pair are not equal: base deepenings and base support segments, sliding deepenings and sliding support segments, base deepenings and sliding deepenings, base deepenings and sliding support segments, base support segments and sliding deepenings, base support segments and sliding support segments.

4. The sliding device according to claim 2, wherein the base deepenings, the base support segments, the sliding deepenings and the sliding support segments are each designed in the same manner, wherein in the radial direction neither does a base ring division which corresponds to a sum of a respective width of the base deepenings and a respective width of the base support segments correspond to a sliding ring division which corresponds to a sum of a respective width of the sliding deepenings and a respective width of the sliding support segments, or to an integer multiple of the sliding ring division, nor does the sliding ring division correspond to an integer multiple of the base ring division.

5. The sliding device according to claim 2, wherein a respective width of the base deepenings is larger than a respective width of the base support segments and/or a respective width of the sliding deepenings is larger than a respective width of the sliding support segments.

6. The sliding device according to claim 2, wherein a respective width of the base deepenings is smaller than a respective width of the base support segments and/or a respective width of the sliding deepenings is smaller than a respective width of the sliding support segments.

7. The sliding device according to claim 1, wherein the base deepenings, the base support segments, the sliding deepenings and/or the sliding support segments are orientated along the sliding axis.

8. The sliding device according to claim 1, wherein the base ring comprises a stop which limits the sliding movement of the sliding ring along the sliding axis.

9. The sliding device according to claim 1, wherein the base ring on the base surface comprises a radially circumferentially closed base sealing section and/or the sliding ring on the sliding surface comprises a radially circumferentially closed sliding sealing section.

10. The sliding device according to claim 1, wherein the base surface faces outwards and wherein the sliding surface faces inwards.

11. The sliding device according to claim 10, wherein the base ring comprises a base sliding surface which is arranged lying opposite the base surface and on which a piston rod of a fluidic cylinder can be mounted in a slidingly movable manner.

12. The sliding device according to claim 11, wherein venting slots pass through the base sliding surface, wherein preferably the venting slots run along the sliding axis.

13. The sliding device according to claim 11, wherein the base ring comprises at least one venting channel through which working fluid can pass through the sliding device independently of the position of the sliding ring to the base ring with respect to the sliding axis.

14. The sliding device according to claim 11, wherein the base ring comprises a stop which limits the sliding movement of the sliding ring along the sliding axis,
wherein the base ring comprises at least one venting channel through which working fluid can pass through the sliding device independently of the position of the sliding ring to the base ring with respect to the sliding axis,
wherein the venting channel passes through the stop from the inside to the outside, wherein at least one of the venting slots runs out into the venting channel.

15. A fluidic cylinder with a sliding device according to claim 1, a cylinder housing in which a working recess is formed, in which working recess a working piston is received, said working piston being linearly movable along a movement axis by way of subjecting the working recess to working fluid, wherein the working piston is connected to a piston rod which passes through an end cap which is arranged on the cylinder housing at the end side, wherein the base ring is fixed to the end cap, wherein the sliding ring is fixed to the working piston.

16. The fluidic cylinder according to claim 15, wherein in the venting position working fluid can exit from the working recess via the sliding deepenings and the base deepenings into an environment which surrounds the fluidic cylinder.

17. The fluidic cylinder according to claim 15, wherein the base surface faces outwards and wherein the sliding surface faces inwards,
wherein the base ring comprises a base sliding surface which is arranged lying opposite the base surface and on which a piston rod of a fluidic cylinder can be mounted in a slidingly movable manner,
wherein the base ring functions as a plain bearing for the working piston or the piston rod.
Fehler! Textmarke nicht definiert.
